(19) United States
(12) Patent Application Publication
(10) Pub. No.: US 2007/0192139 A1
(43) Pub. Date: Aug. 16, 2007

(54) Systems and methods for patient re-identification

(76) Inventors: Ammon Cookson, Hillsboro, OR (US); Stuart Lopez, Lyme, NH (US); Michael I. Lieberman, Portland, OR (US); Thomas N. Ricciardi, Portland, OR (US)

Correspondence Address: MCANDREWS HELD & MALLOY, LTD, 500 WEST MADISON STREET, SUITE 3400, CHICAGO, IL, 60661, US

(21) Appl. No.: 11/469,747

(22) Filed: Sep. 1, 2006

Related U.S. Application Data
(63) Continuation-in-part of application No. 10/420,218, filed on Apr. 22, 2003.
(60) Provisional application No. 60/795,453, filed on Apr. 27, 2006.

(51) Int. Cl. G06F 19/00

(52) U.S. Cl. 705/3

(57) ABSTRACT

Certain embodiments of the present invention provide systems and methods for retrieving and re-identifying patient data. Patient data may be re-identified by retrieving an encrypted or abstracted patient identifier. The identifier is used to retrieve a patient identifier associated with patient identification information. Patient identification information may be inserted into a file, such as a report or other document, at a local computer or web portal for access by an authorized user. A system includes a data storage storing patient data. The patient data includes an encoded patient identifier and an unencoded patient identifier. The system includes a workstation or other processor having a viewing application capable of viewing patient data in a file including the encoded patient identifier. The workstation invokes a procedure to replace the encoded patient identifier in the file at the workstation with the corresponding unencoded patient identifier using the data storage.

### RELATED APPLICATIONS

This application relates to and claims priority from, as a continuation-in-part, U.S. patent application Ser. No. 10/420,218, entitled “Method, System and Computer Product for Securing Patient Identity,” filed on Apr. 22, 2003, which is herein incorporated by reference in its entirety. The application also relates to and claims priority from U.S. Provisional Application No. 60/795,453, entitled “Systems and Methods for Patient Re-Identification,” filed on Apr. 27, 2006, which is herein incorporated by reference in its entirety.

### FEDERALLY SPONSORED RESEARCH OR DEVELOPMENT

Not Applicable

### MICROFICHE/COPYRIGHT REFERENCE

Not Applicable

### BACKGROUND OF THE INVENTION

The present invention generally relates to securing patient identity and, in particular, to de-identifying patient data at an ambulatory patient care provider (PCP) site for submission to a data warehouse system and then re-identify a patient, at the PCP site, from de-identified patient data received from the data warehouse system.

Hospitals typically utilize computer systems to manage the various departments within a hospital and data about each patient is collected by a variety of computer systems. For example, a patient may be admitted to the hospital for a Transthoracic Echo (TTE). Information about the patient (e.g., demographics and insurance) could be obtained by the hospital information system (HIS) and stored on a patient record. This information could then be passed to the cardiology department system (commonly known as the cardio vascular information system, or CVIS). Typically the CVIS is a product of one company, while the HIS is the product of another company. As a result, the database between the two may be different. Further, information systems may capture/retain and send different levels of granularity in the data. Once the patient information has been received by the CVIS, the patient may be scheduled for a TTE in the echo lab. Next, the TTE is performed by the sonographer. Images and measurements are taken and sent to the CVIS server. The reading physician (e.g., an echocardiographer) sits down at a review station and pulls the patient's TTE study. The echocardiographer then begins to review the images and measurements and creates a complete medical report on the study. When the echocardiographer completes the medical report, the report is sent to the CVIS server where it is stored and associated with the patient through patient identification data. This completed medical report is an example of the kind of report that could be sent to a data repository for public data mining. Medication instructions, such as documentation and/or prescription, may also be generated electronically and saved in a data repository.

Data warehousing methods have been used to aggregate, clean, stage, report and analyze patient information derived from medical claims billing and electronic medical records (EMR). Patient data may be extracted from multiple EMR databases located at PCP sites in geographically dispersed locations, then transported and stored in a centrally located data warehouse. The central data warehouse may be a source of information for population-based profile reports of physician productivity, preventative care, disease-management statistics and research on clinical outcomes. The central data warehouse may also be used to benchmark performance across multiple providers of care. Patient data is sensitive and confidential, and therefore, specific identifying information must be removed prior to transporting it from a PCP site to a central data warehouse. This removal of identifying information must be performed per the federal Health Insurance Portability and Accountability Act (HIPAA) regulations. Any data that is contained in a public database must not reveal the identity of the individual patients whose medical information is contained in the database. Because of this requirement, any information contained on a medical report or record that could aid in tracing back to a particular individual must be removed from the report or record prior to adding the data to a data warehouse for public data mining.

In order to accurately assess the impact of a particular drug or treatment on a patient it is helpful to analyze all medical reports relating to the particular patient. Removing data that can be used to trace back to an individual patient can make it impossible to group and analyze all medical reports relating to a particular patient. In addition, one of the aims of population analysis is to assemble an at-risk cohort population comprised of individuals who may be candidates for clinical intervention. However, de-identified data is not very useful to the patient care providers who need to know the identity of their own patients in order to treat them. Additionally, users of the system may need the ability to re-identify patients for further follow-up. Portal users may need to re-identify the patients in a process that doesn't involve the portal system, i.e. the process of re-identification occurs on the local user's system.

Therefore, there is a need for systems and methods for re-identifying patients with respect to medical records. There is a need for systems and methods for secure re-identification of patient records in compliance with HIPAA.

### BRIEF SUMMARY OF THE INVENTION

Certain embodiments of the present invention provide systems and methods for retrieving and re-identifying de-identified or anonymized patient data.

Certain embodiments provide system and methods for re-identifying patient data. Patient data may be re-identified by retrieving an encrypted or abstracted patient identifier. The identifier is used to retrieve a patient identifier associated with patient identification information. Patient identification information may be inserted into a report or other document at a local computer or web portal for access by an authorized user.

Certain embodiments provide a method for localized re-identification of patient data in an authorized environment. The method includes retrieving, within an authorized environment, an encrypted patient identifier from a file. The method also includes locating a patient identifier associated with patient identification information using the encrypted patient identifier. Additionally the method includes inserting, within an authorized environment, the patient identification information into the file.

Certain embodiments provide a patient re-identification system. The system includes a data storage storing patient data. Patient data includes an encoded patient identifier and a patient identifier. The encoded patient identifier corresponds to the patient identifier. The system further includes a processor configured to connect with the data storage. The processor includes a viewing application capable of viewing patient data in a file including the encoded patient identifier. The processor invokes a procedure to replace the encoded patient identifier in the file with the corresponding patient identifier using the data storage. The replacement of the encoded patient data with the corresponding patient identifier occurs via the processor.

Certain embodiments provide at least one computer-readable medium including a set of instructions for execution on a computer. The set of instructions includes a data store including patient-related data. The patient-related data includes at least one encrypted patient identifier and at least one unencrypted patient identifier. The patient-related data is searchable by the at least one encrypted patient identifier and the at least one unencrypted patient identifier. The set of instructions also includes a viewing application configured to view a file including patient data in an authorized environment. In addition, the set of instructions includes a re-identification routine triggered via the viewing application. The re-identification routine selects an encrypted patient identifier in the file and matches the encrypted patient identifier in the file with one of the at least one encrypted patient identifier in the data store. The re-identification routine locates an unencrypted patient identifier corresponding with the encrypted patient identifier and inserts the unencrypted patient identifier into the file in the authorized environment.

### BRIEF DESCRIPTION OF SEVERAL VIEWS OF THE DRAWINGS

FIG. 1 is an exemplary system for securing patient identity in accordance with an embodiment of the present invention.

FIG. 2 is a block diagram of an exemplary data warehouse architecture in accordance with an embodiment of the present invention.

FIG. 3 depicts an exemplary process for de-identifying patient data for storage in a data warehouse used in accordance with an embodiment of the present invention.

FIG. 4 is a block diagram of an exemplary process for re-identifying a patient from de-identified patient data in accordance with an embodiment of the present invention.

FIG. 5 illustrates a flow diagram for a method for re-identifying a patient from de-identified patient data in accordance with an embodiment of the present invention.

FIG. 6 illustrates a system for patient data de-identification and re-identification in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

An exemplary embodiment of the present invention is a secure process for sending de-identified patient information from an ambulatory patient care provider (PCP) site to a data warehouse system where the patient data may be analyzed and compared with a wider range of patient data. The terms “de-identified patient information” and “de-identified patient data” as used in this document refer to both fully de-identified data as defined by HIPAA and limited data set data as defined by HIPAA. A limited data set is protected health information for research, public health and health care operations that excludes direct identifiers (e.g., name; postal address other than city, state and zip code; social security number; medical records numbers) but in which other identifying information may remain (e.g., dates of examination; documentation; diagnosis; prescription; lab test results). This is contrasted with fully de-identified data as defined by HIPAA, where all data that may be used to trace back to an individual patient is removed from the record. Information obtained through the data warehouse that pertains to individual patients is transmitted back to the originating PCP site, via a cohort report. Cohort reports are generated by queries that are executed against the data warehouse system to identify patient cohort groups. The individual patients included in a cohort report are then re-identified at the PCP site so that the PCPs may consider the information when deciding on treatment options for the individual patients.

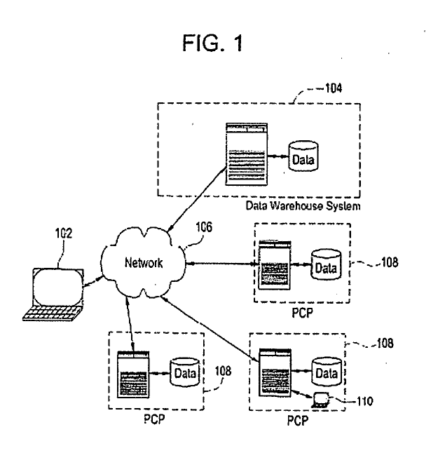

FIG. 1 is an exemplary system for securing patient identity. PCP systems 108 located at various PCP sites are connected to a network 106. The PCP systems 108 send patient medical data to a data warehouse located on a data warehouse system 104. The PCP systems 108 typically include application software to perform data extraction along with one or more storage device for storing the electronic medical records (EMRs) associated with patients treated at the PCP site. In addition, the PCP systems 108 may include PCP user systems 110 to access the EMR data, to initiate the data extraction and to enter a password string to be used for encrypting a patient identifier. The PCP user systems 110 may be directly attached to the PCP system 108 or they may access the PCP system 108 via the network 106. Each PCP user system 110 may be implemented using a general-purpose computer executing a computer program for carrying out the processes described herein. The PCP user systems 110 may be personal computers or host attached terminals. If the PCP user systems 110 are personal computers, the processing described herein may be shared by a PCP user system 110 and a PCP system 108 by providing an applet to the PCP user system 110. The storage device located at the PCP system 108 may be implemented using a variety of devices for storing electronic information such as a file transfer protocol (FTP) server. It is understood that the storage device may be implemented using memory contained in the PCP system 108 or it may be a separate physical device. The storage device contains a variety of information including an EMR database.

In addition, the system of FIG. 1 includes one or more data warehouse user systems 102 through which an end-user may make a request to an application program on the data warehouse system 104 to access particular records stored in the data warehouse (e.g., to create a cohort report). In an exemplary embodiment of the present invention, end-users may include PCP staff members, pharmaceutical or other company research team members and personnel from companies that make medical or other products. The data warehouse user systems 102 may be directly connected to the data warehouse system 104 or they may be coupled to the data warehouse system 104 via the network 106. Each data warehouse user system 102 may be implemented using a general-purpose computer executing a computer program for carrying out the processes described herein. The data warehouse user systems 102 may be personal computers, host attached terminals, software and/or other processors. If the data warehouse user systems 102 are personal computers, the processing described herein may be shared by a data warehouse user system 102 and the data warehouse system 104 by providing an applet to the data warehouse user system 102.

The network 106 may be any type of known network including a local area network (LAN), a wide area network (WAN), an intranet, or a global network (e.g., Internet). A data warehouse user system 102 may be coupled to the data warehouse system 104 through multiple networks (e.g., intranet and Internet) so that not all data warehouse user systems 102 are required to be coupled to the data warehouse system 104 through the same network. Similarly, a PCP system 108 may be coupled to the data mining host system 104 through multiple networks (e.g., intranet and Internet) so that not all PCP systems 108 are required to be coupled to the data warehouse system 104 through the same network. One or more of the data warehouse user systems 102, the PCP systems 108 and the data warehouse system 104 may be connected to the network 106 in a wireless fashion and the network 106 may be a wireless network. In an exemplary embodiment, the network 106 is the Internet and each data warehouse user system 102 executes a user interface application to directly connect to the data warehouse system 104. In another embodiment, a data warehouse user system 102 may execute a web browser to contact the data warehouse system 104 through the network 106. Alternatively, a data warehouse user system 102 may be implemented using a device programmed primarily for accessing the network 106 such as WebTV.

The data warehouse system 104 may be implemented using a server operating in response to a computer program stored in a storage medium accessible by the server. The data warehouse system 104 may operate as a network server (often referred to as a web server) to communicate with the data warehouse user systems 102 and the PCP systems 108. The data warehouse system 104 handles sending and receiving information to and from data warehouse user systems 102 and PCP systems 108 and can perform associated tasks. The data warehouse system 104 may also include a firewall to prevent unauthorized access to the data warehouse system 104 and enforce any limitations on authorized access. For instance, an administrator may have access to the entire system and have authority to modify portions of the system and a PCP staff member may only have access to view a subset of the data warehouse records for particular patients. In an exemplary embodiment, the administrator has the ability to add new users, delete users and edit user privileges. The firewall may be implemented using conventional hardware and/or software as is known in the art.

The data warehouse system 104 also operates as an application server. The data warehouse system 104 executes one or more application programs to provide access to the data repository located on the data warehouse system, as well as application programs to import patient data into a staging area and then into the data warehouse. In addition, the data warehouse system 104 may also execute one or more applications to create patient cohort reports and to send the patient cohort reports to the PCP systems 108. Processing may be shared by the data warehouse user system 102 and the data warehouse system 104 by providing an application (e.g., java applet) to the data warehouse user system 102. Alternatively, the data warehouse user system 102 can include a stand-alone software application for performing a portion of the processing described herein. Similarly, processing may be shared by the PCP system 102 and the data warehouse system 104 by providing an application to the PCP system 102 and alternatively, the PCP system 102 can include a stand-alone software application for performing a portion of the processing described herein. It is understood that separate servers may be used to implement the network server functions and the application server functions. Alternatively, the network server, firewall and the application server can be implemented by a single server executing computer programs to perform the requisite functions.

The storage device located at the data warehouse system 104 may be implemented using a variety of devices for storing electronic information such as a file transfer protocol (FTP) server. It is understood that the storage device may be implemented using memory contained in the data warehouse system 104 or it may be a separate physical device. The storage device contains a variety of information including a data warehouse containing patient medical data from one or more PCPs. The data warehouse system 104 may also operate as a database server and coordinate access to application data including data stored on the storage device. The data warehouse may be physically stored as a single database with access restricted based on user characteristics or it can be physically stored in a variety of databases including portions of the database on the data warehouse user systems 102 or the data warehouse system 104. In an exemplary embodiment, the data repository is implemented using a relational database system and the database system provides different views of the data to different end-users based on end-user characteristics.

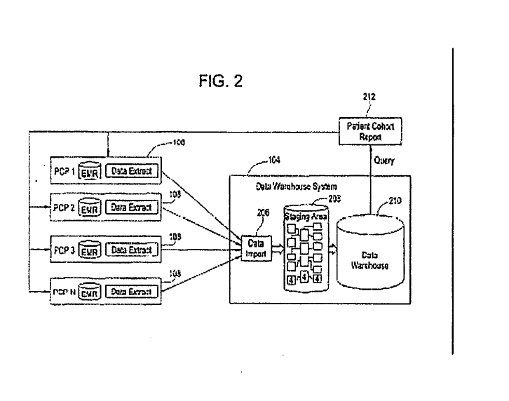

FIG. 2 is a block diagram of an exemplary data warehouse architecture. Patient data is extracted from EMR databases located in the PCP systems 108. In an exemplary embodiment of the present invention, an EMR database record includes data such as: patient name and address, medications, allergies, observations, diagnoses, and health insurance information. The PCP systems 108 include application software for extracting patient data from the EMR database. The data is then de-identified and transported (e.g., via Hypertext Transfer Protocol (HTTPS)) over the network 106 to the data warehouse system 104. The data warehouse system 104 includes application software to perform a data import function 206. The data import function 206 aggregates and cleanses de-identified patient data from multiple sites and then stores the data into a staging area 208. Data received from multiple PCP systems 108 is normalized, checked for validity and completeness, and either corrected or flagged as defective. Data from multiple PCP systems 108 is then combined together into a relational database. Aggregation, cleaning and staging data in the described fashion allows the data to be queried meaningfully and efficiently, either as a single entity or specific to each individual PCP site 108. The de-identified patient data is then staged into a data warehouse 210 where it is available for querying.

Patient cohort reports 212 are generated by application software located on the data warehouse system 104 and returned to the PCP systems 108 for use by the primary care providers in treating individual patients. Patient cohort reports 212 may be automatically generated by executing a canned query on a periodic basis. PCP staff members, pharmaceutical or other company research team members and personnel from companies that make medical or other products may each run patient cohort reports 212. In addition, patient cohort reports 212 may be created by an end-user accessing a data warehouse user system 102 to create custom reports or to initiate the running of canned reports. Further, patient cohort reports 212 may be automatically generated in response to the application software, located on the data warehouse system 104, determining that particular combinations of data for a patient are stored in the data warehouse. An exemplary patient cohort report 212 includes all patients with a particular disease that were treated with a particular medication. Another exemplary patient cohort report 212 includes patients of a particular age and sex who have particular test results. For example, a patient cohort report 212 may list all women with heart disease who are taking a hormone replacement therapy drug. The patient cohort report 212 would list all the patients with records in the data warehouse 210 that fit this criteria along with a warning about the possible side-effects and the likelihood of the side-effects occurring. In an exemplary embodiment, each PCP site receives the entire report, in another embodiment, each PCP site receives the report only for patients that are being treated at the PCP site.

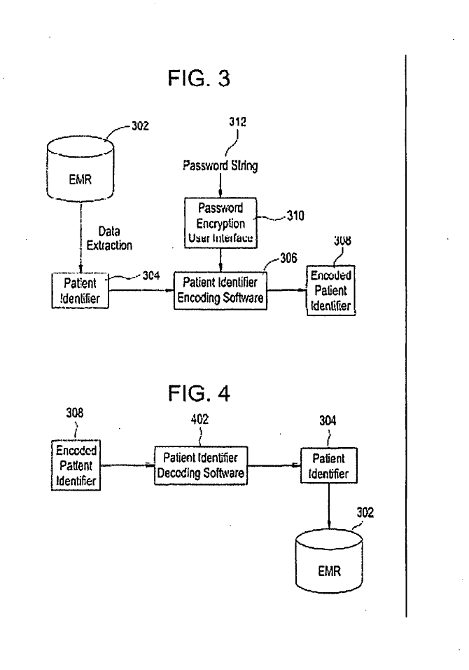

In an exemplary embodiment of the present invention, the ability to create patient cohort reports 212 based on querying longitudinal patient data is supported by the ability to connect all records relating to a single patient in the data warehouse 210. This requires a unique identifier to be associated with each patient record that is transmitted to the data warehouse 210. The unique identifier must not be traceable back to an individual patient by end-users accessing the data warehouse 210. However, individual PCPs may want to retain the ability to re-identify a patient based on the unique identifier so that the medical personnel located at the PCP site can follow through with the patient in response to information included in the patient cohort reports 212. FIG. 3 depicts an exemplary process for de-identifying patient data for storage in a data warehouse 210 located at the data warehouse system 104 and FIG. 4 depicts an exemplary process for re-identifying a patient from the de-identified patient data contained in a patient cohort report 212.

FIG. 3 is a block diagram of an exemplary process for de-identifying patient data during data extraction for transmission to a data warehouse system 104. The de-identification process removes information that will identify a patient while still retaining clinically useful information about the patient. Patient data is extracted from the EMR database 302 and identifying information is removed, resulting in de-identified patient data. In an exemplary embodiment of the present invention, an EMR database 302 includes the following patient identifying demographic data: names; geographic identifiers, including address; dates directly related to an individual, including birth date, admission date, discharge date and date of death; telephone and fax numbers; electronic mail addresses; social security number; medical record number; health plan beneficiary; account numbers; certificate or license numbers; vehicle identifiers and serial numbers including license plate numbers; device identifiers and serial numbers, web Universal Resource Locators (URLs) and internet protocol (IP) address numbers; biometric identifiers, including finger and voice prints; full face photographic images and comparable images; other unique identifying numbers, characteristics and codes assigned by the PCP or by the EMR system for administrative purposes, including a patient identifier (PID) 304. The EMR database 302 also includes information about: the patient diagnosis or problem; medications taken or prescribed; observations, diagnostic laboratory tests and vital signs; subjective and objective findings, assessments, orders, plans, and notes documented by healthcare providers. The EMR database 302 also includes audit information that records the date, time, and identity of persons who have created, read, updated, or deleted information from the patient record. The EMR database 302 record for each patient also contains a numeric key known as the PID 304 which may be used to uniquely identify an individual patient. The PID 304 is encoded as part of the de-identification process to create an encoded patient identifier (EPID) 308. The EPID 308 is sent, along with the de-identified patient data, to the data warehouse system 104.

The extraction process is performed by application software located on the PCP system 108 and may be executed in the background on a periodic basis (e.g., at 2 a.m. every night, at 2 a.m. every Saturday). In this manner, the extraction process will be less likely to interfere with existing software located on the PCP system 108. The extraction process may also be initiated by a remote system (e.g., the data warehouse system 104) and may include full or incremental back-up schemes. In an exemplary embodiment of the present invention, the following identifiers are removed or transformed in order to create de-identified data that would be classified under the HIPAA definition as fully de-identified data: name, geographic subdivisions smaller than a state including street address, city, county, precinct, zip code (down to the last three digits), dates directly related to an individual (e.g., birth date), phone and fax numbers, electronic mail addresses, health plan number, account number, certificate/license number, device identifier and serial numbers, unified resource locator (URL), internet protocol (IP) address, biometric identifiers, full face photograph, and other unique identifying numbers, characteristics or codes.

In an alternate exemplary embodiment of the present invention, the following identifiers are removed or transformed in order to create de-identified that that would be classified under the HIPAA definition as limited data set information: direct identifiers such as name, postal address (other than city, state and zip code), social security number and medical records numbers. In the limited data set information implementation of the present invention some identifying information may remain such as dates of examination, documentation, diagnosis, prescription and lab test results.

A novel EPID 308 is assigned to each patient based on the PID 304 associated with the patient and a password entered by the PCP. The PID 304 to EPID 308 mapping is not maintained persistently. As depicted in the exemplary embodiment shown in FIG. 3, a password string 312 is supplied by the PCP via a password encryption user interface 310 on the PCP user system 110. This password string 312 is known only to the PCP and is required in order to decode the EPID 308 into a PID 304. The user at the PCP site must have the password string 312 to obtain the PID 304 and this password string 312 must be re-entered each time a patient is to be re-identified. The password encryption user interface 310 may be a graphical user interface. In an exemplary embodiment of the present invention, the user entered password string 312 is encoded using the two-fish algorithm. The two-fish algorithm, as known in the art, is a secret-key block cipher cryptography algorithm that is designed to be highly secure and highly flexible. It utilizes a single key for both encryption and decryption and is often referred to as symmetric encryption. The encoding is performed by patient identifier encoding software 306 located on the PCP system 108. The patient identifier encoding software 306 also hashes the encoded password string to produce a number, such as a sixteen-digit number. This sixteen-digit number is numerically added to the PID 304 to create the EPID 308. Other methods of creating the EPID 308 from the PID 304 may be utilized with an exemplary embodiment of the present invention (e.g. Rivest, Shamir and Adelman, or RSA) as long as the EPID may only be decoded at the PCP site.

FIG. 4 is a block diagram of an exemplary process for re-identifying a patient from de-identified patient data. As described previously, population cohort reports 212 of at-risk patients are created by running queries against the data warehouse 210. De-identified individuals may be tracked longitudinally and queried as members of anonymous population cohorts, based on clinical selection criteria. The query result, contained in the cohort report 212, is a list of EPIDs 308. A list of patient EPIDs 308 in a patient cohort report 212 are received by the PCP system 108. The EPIDs 308 are read into the patient identifier decoding software 402, located on the PCP system 108, and the original PID 304 is recreated. The PID 304 may be used as a key to look up additional identifying information from the EMR database 302. Employees of the PCP may utilize the patient-specific information from the EMR database 302 to counsel the patient and to decide on treatment alternatives.

An embodiment of the present invention allows for ambulatory PCPs to send patient data into a data warehouse containing patient data from other ambulatory PCPs. In this manner, patient data may be analyzed and compared to a larger population of patients. The de-identified patient data includes an EPID 308 that may be useful in creating longitudinal reports that analyze more than one record for a particular patient. The effects of certain drugs and treatments on patient cohort groups can be analyzed and may lead to improvements in the use or composition of the drugs and treatments. In addition, an embodiment of the present invention allows for the PCP to receive cohort reports 212 based on data contained in the data warehouse. These patient cohort reports 212 include an EPID 308 for each patient. The EPID 308 may be decoded at the PCP site that created the EPID 308 and used to identify a particular patient. In this manner a PCP, by considering the information contained in the cohort report, may be able to provide improved treatment to the patient. This ability to provide useful information back to a patient level may also lead more PCPs to participate in sending patient data to a data warehouse. Having more data in the data warehouse may provide more useful information to third parties such as pharmaceutical companies, medical device companies and physicians about the effects and risks of particular treatments, while minimizing the risk of disclosing patient-identifying information to third parties. This may lead to improvements in preventative care as well as other types of medical care.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. An embodiment of the present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

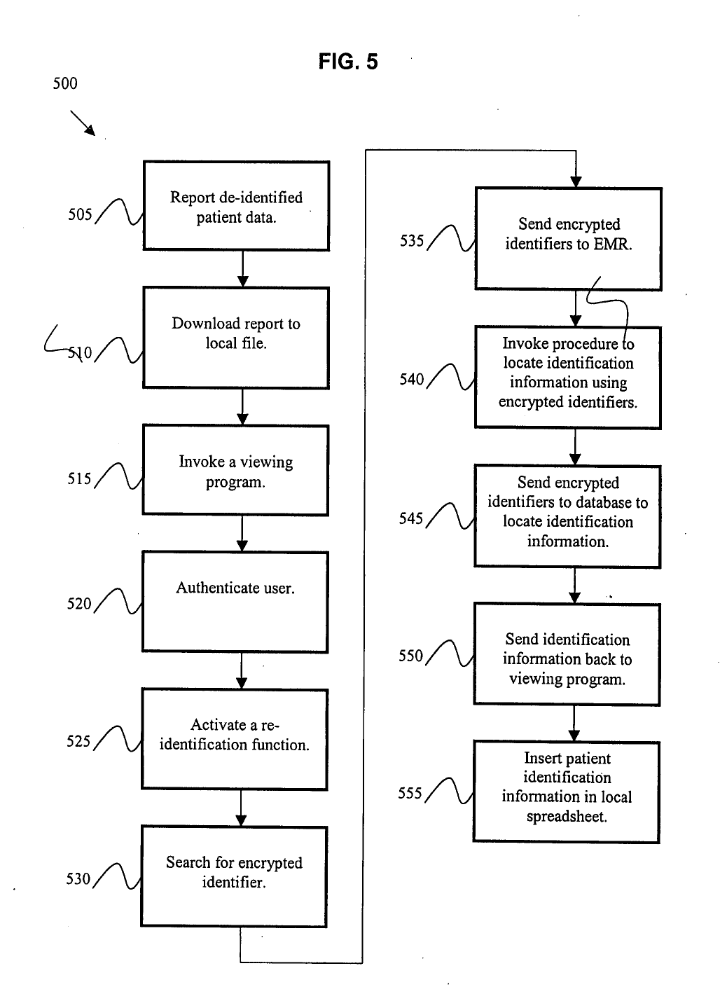

FIG. 5 illustrates a flow diagram for a method 500 for re-identifying a patient from de-identified patient data in accordance with an embodiment of the present invention. First, at step 505, de-identified patients are reported or otherwise listed in a file, such as a report, such as a web-based report, or other listing or document. For example, a healthcare practitioner may select one or more de-identified patient records from a patient list or web-based patient report via an interface, such as a web-based portal or other software-based user interface. A user may select and/or generate a report or listing of patients meeting a certain criteria (e.g., diabetes, heart disease, gender, age, etc.), for example. At step 510, the web report is downloaded into a local file. For example, the data retrieved via the web-based or other network portal may be manually or automatically downloaded from the network source to a local file on the user's computer, local network system, software and/or other processor in an authorized environment. An authorized environment is a system or other operating environment authorized to view and/or manipulate patient identification data, such as a HIPAA compliant medical practitioner's office.

At step 515, the user invokes a viewing program, such as Microsoft Excel® or other spreadsheet or reporting software. Alternatively, the viewing program may be launched automatically upon download of the patient-related data. At step 520, from within the viewing program, the user is authenticated with an EMR system to ensure the user has proper authorization to view patient chart information. For example, a user's password, signature and/or biometric identification may be verified to authorize access to patient data. Without user authentication, a user may not be able to execute stored EMR procedures. For example, an authentication mechanism residing in an EMR host system may be invoked for user name and password as well as verify a privilege level.

At step 525, the user selects or otherwise activates a re-identification function with respect to de-identified patient data. For example, an icon, button, menu option and/or command may be added to the viewing program to activate or trigger execution of the re-identification function for all of the displayed patient data entries or a selected subset of the entries. At step 530, the viewing program, such as Excel, searches column headers or other field(s) of the report for a column and/or field containing an encrypted identifier, such as an EPID. It should be understood that encrypted is used herein to indicate that the identifier or patient information is encoded, de-identified, abstracted, anonymous and/or otherwise encrypted to protect patient privacy. For example, a file, such as a worksheet, spreadsheet, table or other document, may be scanned for a column header or other field identifying an appropriate column or series of data to be re-identified.

Once the column is located, at step 535, the program collects the set of EPIDs and sends this to an EMR system and/or database or data warehouse through a data communication connection, such as a data connection (e.g., an Open DataBase Connectivity (ODBC) or an Object Linking and Embedding DataBase (OLE DB) connection). For example, the file document may be scanned to identify which one of the column headers or other field identifiers corresponds to a Patient column or similar structure. Then, for example, the set of EPIDs from the patient report are sent to an electronic medical record data warehouse via a compliant connection. The selected or identified EPIDs found in the patient column may be organized in an array or other data structure, for example.

At step 540, a stored procedure in the EMR database is invoked to augment the EPIDs with patient identifiable information such as a patient identifier (e.g., a PID), patient first name, patient last name, etc. The EMR database may be a HIPAA-compliant database, data warehouse and/or other data store, for example. At step 545, the array or other structure of EPIDs is scanned, and, for every EPID pulled from the patient column, a record or other data is sent via a data connection (e.g., ODBC or OLE DB) to the EMR database, and a re-identification stored procedure is invoked to pull a resultant first name, last name, etc. For example, the stored procedure may call a database resident algorithm which passes an internal identifier to the procedure. In certain embodiments, a hash function is used to generate a PID from the EPID, for example. Alternatively, an offset, algorithm based on patient name, age and social security number and/or other algorithm may be used to generate an internal identifier for a patient record, for example. The internal identifier is passed as parameter for a query which in turn returns name and/or or other identification information corresponding an EPID record. For example, the PID or other identifier may be used to index or search records in the database to identify appropriate record(s).

At step 550, the identification information is then sent back to the viewing application, such as Microsoft™ Excel or other spreadsheet or database program. At step 555, columns and/or other fields are inserted and/or replaced in the file, such as a spreadsheet or other document, for the patient identifiable information (e.g., patient id, first name, last name, etc.). For example, PID and/or patient name columns and/or fields may be added to a file and/or may overwrite EPID and/or other columns or fields in the file.

One or more of the steps of the method 500 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

In certain embodiments, once patient information is re-identified, the user may send the corresponding list of patients into EMR as an inquiry for further analysis, manipulation, etc. A re-identified patient record may be modified, compared, and/or otherwise manipulated by the authorized user and saved locally and/or in an EMR database or other storage. A modified record may be de-identified before is it saved, for example.

In certain embodiments, EMR updates are “pulled”, “pushed”, or otherwise communicated to a database, data warehouse and/or other data store on a periodic basis (e.g., nightly, weekly, etc.). In certain embodiments, changes made locally to re-identified patient records are de-identified and communicated to the EMR system and/or database for storage.

In certain embodiments, a user may search for one or more patient records within EMR by invoking a “find” dialog or search function. The user may search by the EPID, for example, and enter or select an EPID number to activate a search. The corresponding patient chart may be retrieved and displayed. Thus, a patient may be re-identified for an authorized healthcare provider who has been identified and verified.

Thus, re-identification is a mechanism or pattern that enables encrypted and re-encrypted data to work in physically separated systems together. Whereas the encrypted system may host patient-level information that's HIPAA compliant and provide features that are useful from an encrypted point of view (e.g. provide data views to a larger audience, etc.), a need exists to leverage the information from the encrypted system and to re-identify the information for those audiences who are physically separated from the encrypted system but who have the authorization to view patient identifiable information (e.g., an authorized environment). The process of re-identifying the patients is a process that occurs, for example, on the local system.

In certain embodiments, separation of de-identified and identified patient data facilitates broader analysis of patient populations without breaching individual patient security. Population-based analysis may be performed safely while maintaining patient privacy. Re-identification may occur at the local system level to allow a patient's healthcare provider to diagnose, treat and/or provide other services to the patient.

Thus, broader analysis of patient information may be allowed while at the same time respecting patient privacy. Communities of health care providers may benchmark, and compare patient populations without compromising patient privacy. At the same time, a patient's provider may re-identify patients from within the patient populations at the local level that are hosted/presented by the encrypted site. Re-identification algorithms may be stored locally at the healthcare provider level, for example. This physical separation may limit a potential risk of other providers who are viewing de-identified data on a portal from viewing patient identifiable information.

Certain embodiments allow for patient information to be shared with interested parties without compromising patient privacy. In the broader healthcare space, there will be applications where researchers, government agencies, communities of practice, may want to study patient populations but are, as of now, restricted because no good mechanism exists to work with source data providers in de-identifying and re-identifying patients. Certain embodiments facilitate such interaction. For example, decrypted information may be re-identified and then consumed by or imported into a patient's provider system within Microsof™ Excel, Centricity Physician Office EMR application and/or other application. Other entities, such as researchers and agencies, may view and/or manipulate the encrypted or de-identified data with reduced risk of compromising patient privacy.

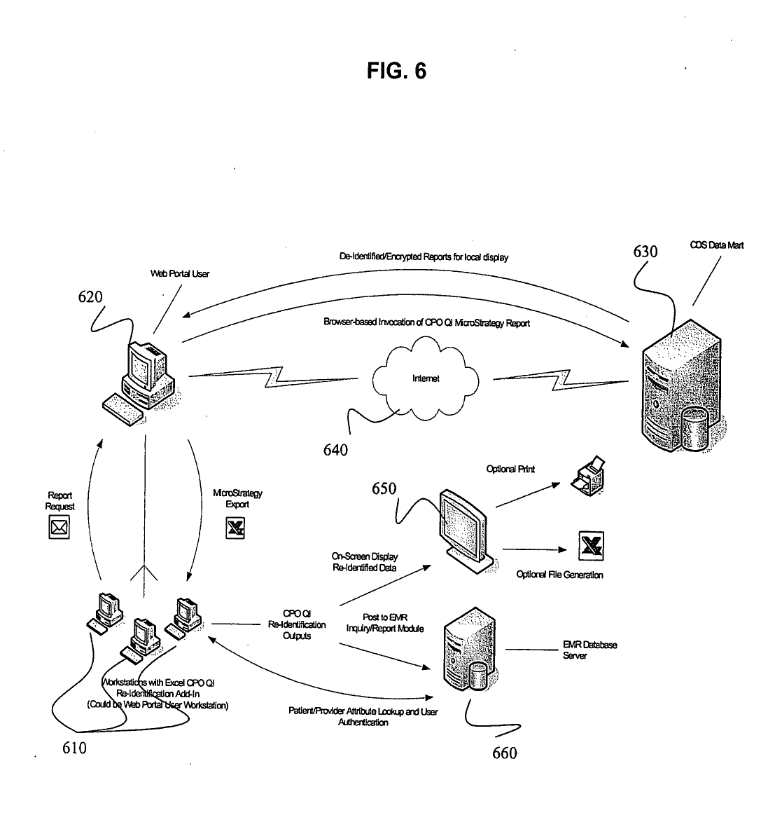

FIG. 6 illustrates a system 600 for patient data de-identification and re-identification in accordance with an embodiment of the present invention. The system 600 includes one or more user workstations 610, a web portal 620, a data store 630 and a data link 640. The system 600 may also include a display 650 and/or a data server 660, for example. The system 600 may include one or more software processes, computers and/or other processors instead of and/or in addition to the workstation(s) 610, for example. The system 600 may include one or more web services instead of and/or in addition to the web portal 620, for example.

The components of the system 600 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. Certain components may be integrated in various forms and/or may be provided as software and/or other functionality on a computing device, such as a computer. Certain embodiments may omit one or more of the components of the system 600 to execute the re-identification and/or de-identification functions and communicate data between a local user and a data store.

In operation, the workstation 610 or other processor may request data via the web portal 620 or other web service. For example, a user at the workstation 610 requests patient-related data via a web browser that accesses the web portal 620. The web portal 620 communicates with the data store 630 via a data link 640. For example, the web portal 620 requests the data from the data store 630, such as from an EMR data mart, via a network, such as the Internet or a private network. The data store 630 returns the requested data to the workstation 610 via the web portal 620. The data may include non-HIPAA-protected data, de-identified/encrypted patient data, re-identified patient data, and/or other data, for example.

The user workstation 610 may communicate with the display 650 to display data transmitted from the data store 630. Data may also be printed and/or used to generate a file, for example. The workstation 610 may also communicate with the data server 660 to transmit the data and/or other update, for example.

In certain embodiments, a de-identified patient report is transmitted to the workstation 610 from the data store 630 via the web portal 620 in response to a request from the workstation 610. The workstation 610 performs a re-identification of the de-identified patient data locally at the workstation 610. The re-identification may be performed via lookup of an EPID to determine a corresponding PID or other similar technique, for example. The re-identification functionality may be integrated into a document viewing/editing program, such as Microsoft Excel, Microsoft Word, and/or other software, for example. The re-identification function may access data in an external source, such as the data store 630 and/or the data server 660, to match the EPID to the PID. In certain embodiments, the EPID is replaced with the PID and/or other patient identifying information (e.g., patient name) in a document at the workstation 610.

In certain embodiments, the workstation 610 may first authenticate a privilege or right of access via the server 660, for example, before the patient data is re-identified. The workstation 610 may also lookup patient and/or provider attributes via the server 660 and/or data store 630, for example.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method for localized re-identification of patient data in an authorized environment, said method comprising:
retrieving, within an authorized environment, an encrypted patient identifier from a file;
locating a patient identifier associated with patient identification information using said encrypted patient identifier; and
inserting, within an authorized environment, said patient identification information into said file.

2. The method of claim 1, further comprising downloading said file to a workstation via a web service.

3. The method of claim 1, wherein said locating step further comprises locating said patient identifier associated with patient identification information in a database using said encrypted patient identifier.

4. The method of claim 1, wherein said file comprises a report of patients meeting a criterion, wherein said patients are anonymous in said report.

5. The method of claim 1, wherein said authorized environment comprises an authorized processor.

6. The method of claim 1, further comprising:
modifying said file; and
automatically uploading said file from said authorized environment to a data warehouse at a predetermined schedule.

7. The method of claim 1, further comprising:
modifying said document with said inserted patient identification information;
replacing said patient identification information with said encrypted patient identifier; and
saving said file in a database.

8. The method of claim 1, further comprising authenticating a user to re-identify said patient data.

9. A patient re-identification system, said system comprising:
a data storage storing patient data, wherein patient data includes an encoded patient identifier and a patient identifier, said encoded patient identifier corresponding to said patient identifier; and
a processor configured to connect with said data storage, said processor including a viewing application capable of viewing patient data in a file including said encoded patient identifier,
wherein said processor invokes a procedure to replace said encoded patient identifier in said file with said corresponding patient identifier using said data storage, and
wherein said replacement of said encoded patient data with said corresponding patient identifier occurs via said processor.

10. The system of claim 9, further comprising a web service configured to download said file to an authorized environment including said processor.

11. The system of claim 9, wherein said file comprises a report of patients meeting a criterion, wherein said patients are anonymous in said report.

12. The system of claim 9, wherein said file is modified using said processor and automatically uploaded using said processor to said data storage at a predetermined schedule.

13. The system of claim 9, wherein said procedure is incorporated in a viewing application executed using said processor, said viewing application configured to view said file, said procedure interfacing between said viewing application and said data storage.

14. The system of claim 9, wherein said processor comprises a processor in an environment authorized to view patient identification data.

15. At least one computer-readable medium including a set of instructions for execution on a computer, said set of instructions comprising:
a data store including patient-related data, said patient-related data including at least one encrypted patient identifier and at least one unencrypted patient identifier, said patient-related data searchable by said at least one encrypted patient identifier and said at least one unencrypted patient identifier;
a viewing application configured to view a file including patient data in an authorized environment; and
a re-identification routine triggered via said viewing application, said re-identification routine selecting an encrypted patient identifier in said file and matching said encrypted patient identifier in said file with one of said at least one encrypted patient identifier in said data store, said re-identification routine locating an unencrypted patient identifier corresponding with said encrypted patient identifier and inserting said unencrypted patient identifier into said file in said authorized environment.

16. The set of instructions of claim 15, wherein said viewing application automatically uploads said report from said authorized environment to said data store at a predetermined schedule.

17. The set of instructions of claim 15, further comprising a de-identification routine for replacing an unencrypted patient identifier with a corresponding encrypted patient identifier.

18. The set of instructions of claim 15, wherein said file comprises a report of patients meeting a criterion, wherein said patients are anonymous in said report.

19. The set of instructions of claim 15, wherein said viewing application comprises a web-based application.

20. The set of instructions of claim 15, wherein said data store comprises an electronic medical record data storage.
